(19) United States
(12) Patent Application Publication
(10) Pub. No.: US 2025/0377438 A1
(43) Pub. Date: Dec. 11, 2025

(54) SIGNAL CONFLICT DETECTING METHOD AND SIGNAL TRANCEIVING DEVICE

(71) Applicant: Realtek Semiconductor Corp., HsinChu (TW)

(72) Inventors: Mingzhi Guo, Suzhou City (CN); Ying Yang, Suzhou City (CN); Yiqi Jiang, Suzhou City (CN)

(73) Assignee: Realtek Semiconductor Corp., HsinChu (TW)

(21) Appl. No.: 19/181,422

(22) Filed: Apr. 17, 2025

(30) Foreign Application Priority Data
Jun. 27, 2024 (CN) 202410850312.5

(51) Int. Cl. G01S 7/02

(52) U.S. Cl. CPC G01S 7/0232

(57) ABSTRACT

A signal conflict detecting method, which comprises: (a) the signal transceiving device performing a first detecting operation to detect whether a signal conflict may occur in a target frequency band; (b) the signal transceiving device transmitting a target signal if the signal conflict will not occur in the target frequency band; (c) the signal transceiving device performing a second detecting operation to detect whether the signal conflict may occur in the target frequency band, after transmitting the target signal in the step (b); (d) the signal transceiving device performing a third detecting operation to detect whether the signal conflict may occur in the target frequency band, if the step (c) determines that the signal conflict may occur in the target frequency band; and (e) the signal transceiving device retransmitting the target signal if the step (d) determines that the signal conflict will not occur in the target frequency band.

### BACKGROUND OF THE INVENTION

### 1. Field of the Invention

The present invention relates to a signal conflict method and a signal transceiving device, and particularly relates to a signal conflict method and a signal transceiving device which can avoid the interference of self-circuit signals and signal conflict detecting with a higher efficiency.

### 2. Description of the Prior Art

In modern society, wireless communication systems are quite popular and diversified. In addition to common wireless communication systems such as 5G systems and Wifi systems, microwave sensors (such as radars) are also common wireless communication systems. Microwave sensors are usually used in communications that may be more urgent, such as military or weather conditions. Therefore, in order to avoid signal transmission conflicts (for example, overlapping frequency bands are used) between different systems, signal conflict detection is performed. However, the signals from microwave sensors are usually pulse signals. Therefore, if too many frequency bands are allocated to microwave sensors in order to avoid signal conflicts, free frequency bands may be wasted.

### SUMMARY OF THE INVENTION

One objective of the present invention is to provide a signal conflict detecting method which is more accurate and more affective.

Another objective of the present invention is to provide a signal transceiving device which can more accurately and more affectively detect signal conflict.

One embodiment of the present invention discloses a signal conflict detecting method, which is applied to a signal transceiving device. The signal conflict detecting method comprises: (a) the signal transceiving device performing a first detecting operation to detect whether a signal conflict may occur in a target frequency band to generate a first detecting result; (b) the signal transceiving device transmitting a target signal if the first detecting result indicates that the signal conflict will not occur in the target frequency band, and the signal transceiving device not transmitting the target signal if the first detecting result indicates that the signal conflict may occur in the target frequency band; (c) the signal transceiving device performing a second detecting operation to detect whether the signal conflict may occur in the target frequency band to generate a second detecting result, after transmitting the target signal in the step (b); (d) the signal transceiving device performing a third detecting operation to detect whether the signal conflict may occur in the target frequency band, if the second detecting result indicates that the signal conflict may occur in the target frequency band; and (e) the signal transceiving device retransmitting the target signal if the third detecting result indicates that the signal conflict will not occur in the target frequency band, and the signal transceiving device not retransmitting the target signal if the third detecting result indicates that the signal conflict may occur in the target frequency band.

One embodiment of the present invention discloses a signal transceiving device comprising a transmitting circuit, a receiving circuit; and a processing circuit. The processing circuit is configured to control the transmitting circuit and the receiving circuit to perform following steps: (a) the receiving circuit performing a first detecting operation to detect whether a signal conflict may occur in a target frequency band to generate a first detecting result; (b) the transmitting circuit transmitting a target signal if the first detecting result indicates that the signal conflict will not occur in the target frequency band, and the transmitting circuit not transmitting the target signal if the first detecting result indicates that the signal conflict may occur in the target frequency band; (c) the receiving circuit performing a second detecting operation to detect whether the signal conflict may occur in the target frequency band to generate a second detecting result, after transmitting the target signal in the step (b); (d) the receiving circuit performing a third detecting operation to detect whether the signal conflict may occur in the target frequency band, if the second detecting result indicates that the signal conflict may occur in the target frequency band; and (e) the transmitting circuit retransmitting the target signal if the third detecting result indicates that the signal conflict will not occur in the target frequency band, and the transmitting circuit not retransmitting the target signal if the third detecting result indicates that the signal conflict may occur in the target frequency band.

The present invention has multiple advantages by performing detecting operations before and after transmitting the target signal. For example, when the transmitting circuit TX transmits the target signal, it may cause noise in the receiving circuit RX, which will affect the accuracy of the receiving circuit RX when performing detecting operations. Thus, perform detecting operations before and after transmitting the target signal may increase the accuracy of detecting operations.

For another example, the LNA 203 in the receiving circuit RX will also amplify the noise, thus performs the detecting operation after transmitting the target signal may avoid the noise caused by the transmitting circuit TX to the receiving circuit RX when transmitting the target signal. By this way, the LNA 203 can have a larger amplifying factor and improves the efficiency of the energy detecting circuit 211 in detecting signal energy.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a signal transceiving device according to one embodiment of the present invention.

FIG. 2 is a more detail circuit of the transmitting circuit and the receiving circuit stated in FIG. 1, according to one embodiment of the present invention.

FIG. 3 and FIG. 4 are schematic diagrams illustrating operations of the signal transceiving device according to different embodiments of the present invention.

FIG. 5 is a flow chart illustrating operations of the signal transceiving device according to one embodiment of the present invention.

FIG. 6 is a schematic diagram illustrating that the second detecting operation is performed after a predetermined time following a time point when the transmitting circuit transmits the target signal.

FIG. 7 is a flow chart illustrating a signal conflict detecting method according to one embodiment of the present invention.

### DETAILED DESCRIPTION

Several embodiments are provided in following descriptions to explain the concept of the present invention. The term “first”, “second”, “third” in following descriptions are only for the purpose of distinguishing different one elements, and do not mean the sequence of the elements. For example, a first device and a second device only mean these devices can have the same structure but are different devices.

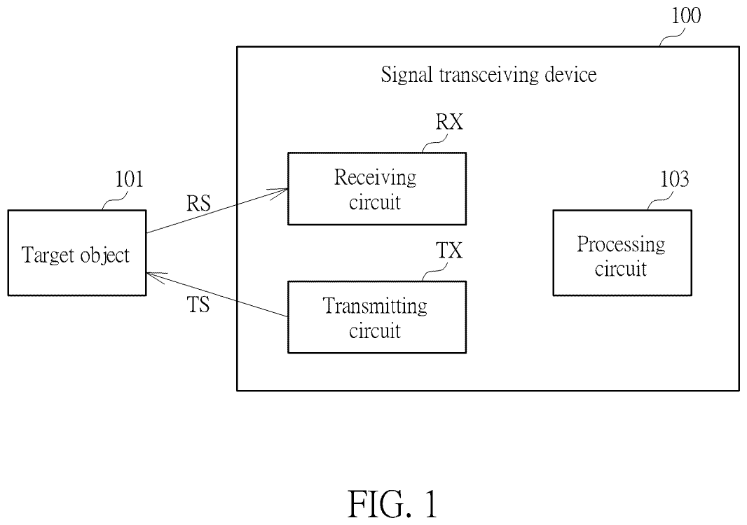

FIG. 1 is a block diagram illustrating a signal transceiving device according to one embodiment of the present invention. As shown in FIG. 1, the signal transceiving device 100 comprises a transmitting circuit TX, a receiving circuit RX and a processing circuit 103. The transmitting circuit TX is configured to transmit a target signal TS, and the receiving circuit RX is configured to receive the reflected signal RS. The reflected signal RS may be generated when the target signal TS is reflected by the target object 101. In the following embodiments, the signal transceiving device 100 is a monostatic radar, that is, a microwave sensor, but it is not limited thereto. The processing circuit 103 is configured to control the operation of the signal transceiving 100.

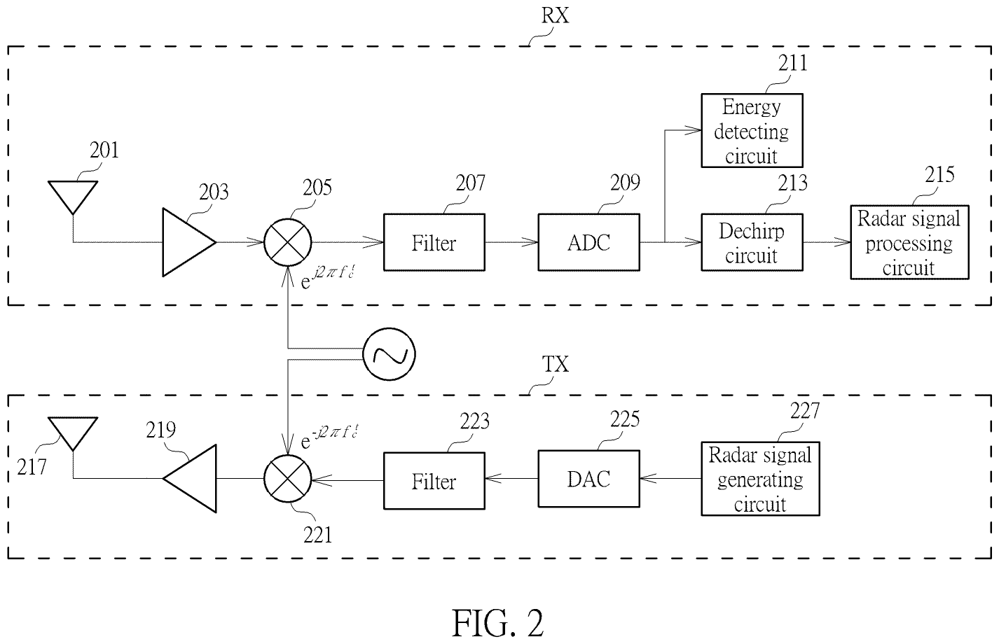

FIG. 2 is a more detail circuit of the transmitting circuit and the receiving circuit stated in FIG. 1, according to one embodiment of the present invention. As shown in FIG. 2, the receiving circuit RX comprises a receiving antenna 201, an LNA (Low Noise Amplifier) 203, a mixer 205, a filter 207, and an ADC (Analog to Digital Converter) 209, an energy detecting circuit 211, a dechirp circuit 213 and a radar signal processing circuit 215. The transmitting circuit TX comprises a transmitting antenna 217, a power amplifier 219, a mixer 221, a filter 223, a DAC 225 and a radar signal generating circuit 227. The mixer 205 and the mixer 221 respectively adjust the frequency of the signal to the frequency required by the receiving circuit RX and the transmitting circuit TX.

The radar signal generating circuit 227 generates a signal, and a target signal TS is sent out through the transmitting antenna 217 after the signal is processed by the DAC 225, the filter 223, the mixer 221 and the power amplifier 219. The receiving antenna 201 receives the reflected signal RS, and after the reflected signal RS is processed by the LNA 203, the mixer 205, the filter 207, and the ADC 209, the reflected signal RS is subsequently processed by a dechirp circuit 213 and a radar signal processing circuit 215. The energy detecting circuit 211 can be used to perform detecting operations, and its detailed operations will be described in detail below.

Please also note that FIG. 2 is only an example for explaining, and the signal transceiving device used in the present invention is not limited to the example shown in FIG. 2. In addition, the components shown in FIG. 2 are not limited to independent circuits or devices, they can also achieve the same functions by using software or firmware. Moreover, all components can also be integrated into fewer components or split into more components.

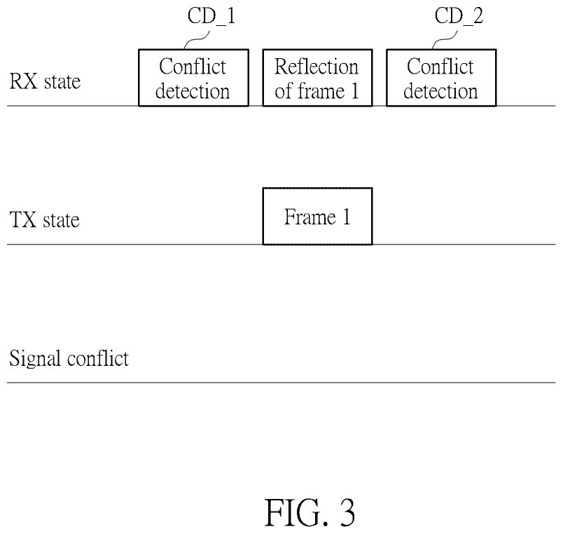

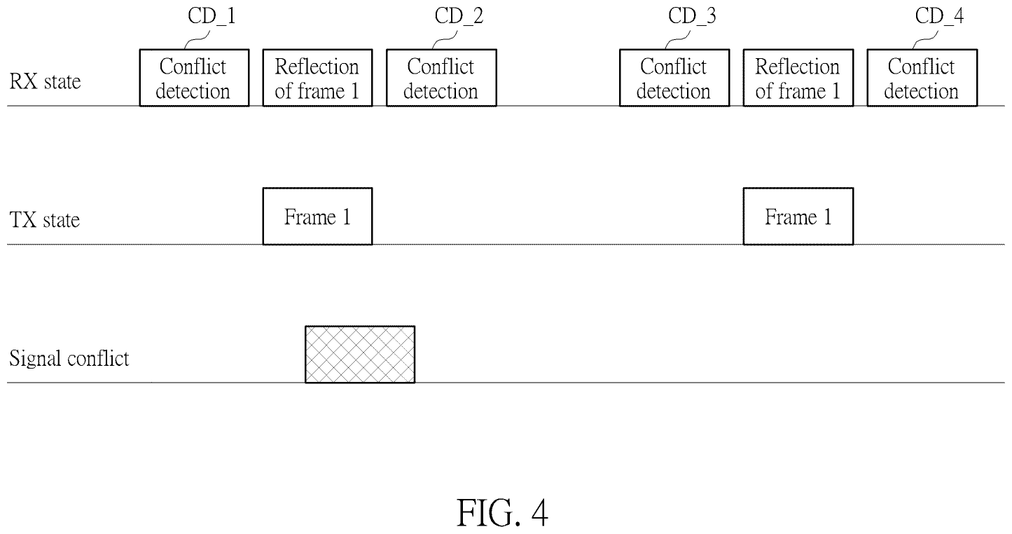

FIG. 3 and FIG. 4 are schematic diagrams illustrating operations of the signal transceiving device according to different embodiments of the present invention. In the embodiment of FIG. 3, the receiving circuit RX performs a first detecting operation CD_1 to detect whether a signal conflict may occur in a target frequency band to generate a first detecting result. In one embodiment, the energy detecting circuit 211 in FIG. 2 detects the energy of the signal. If the signal energy is larger than a conflict threshold, it means that there should be signal interference in the target frequency band (that is, there may be a signal is using at least portion of the target frequency band), thus the first detecting result is that signal conflict may occur in the target frequency band, so the transmitting circuit TX does not transmit the target signal. On the contrary, if the signal energy is less than the conflict threshold, that is, there is no signal interference in the target frequency band or the signal interference is small, then the first detecting result is that no signal conflict will occur in the target frequency band. If the first detecting result indicates that there will be no signal conflict in the target frequency band, the target signal is transmitted through the transmitting circuit TX (for example, frame 1 in FIG. 3). However, the present invention is not limited to detecting whether signal conflict may occur in the target frequency band by detecting energy.

After transmitting the target signal, the receiving circuit RX performs a second detecting operation CD_2 to detect whether signal conflict may occur in the target frequency band to generate a second detecting result. The transmitting circuit TX determines whether to retransmit the target signal or not based on the second detecting result. In the embodiment of FIG. 3, because there is no signal interference or the signal interference is very small (i.e., the second detecting result indicates that there will be no signal conflict in the target frequency band), so the target signal can be successfully transmitted without the need to retransmit it again.

In the embodiment of FIG. 4, the second detecting result indicates that signal conflict may occur in the target frequency band (marked with slashes in FIG. 4), then the receiving circuit RX performs a third detecting operation CD_3 to detect whether signal conflict may occur in the target frequency band to generate a third detecting result. The third detecting operation CD_3 and the second detecting operation CD_2 may be separated by a time interval, and this time interval may vary responding to the design or the abilities of the device or circuit. If the third detecting result indicates that signal conflict will not occur in the target frequency band, then the target signal (for example, frame 1 is retransmitted) is retransmitted via the transmitting circuit TX. If the third detecting result indicates that signal conflict may occur in the target frequency band, then the target signal is not retransmitted via the transmitting circuit TX.

In the embodiment of FIG. 4, after the transmitting circuit TX retransmits the target signal, the receiving circuit RX may perform a fourth detecting operation CD_4 to detect whether a signal conflict may occur in the target frequency band to generate a fourth detecting result. The transmitting circuit TX determines whether to retransmit the target signal or not based on the fourth detecting result. The detailed operations related to the fourth detecting operation CD_4 are the same as the second detecting operation CD_2, thus are omitted for brevity here. However, in other embodiments, in the operation of retransmitting the target signal, the detecting operation may only be performed before the target signal is transmitted but not performed after the target signal is transmitted. In other words, only the third detecting operation CD_3 is performed but the fourth detecting operation CD_4 is not performed. In one embodiment, if the target signal is retransmitted too many times without success, the transmission of the current target signal (frame 1) is abandoned. After successful transmission (such as the embodiment in FIG. 3), successful retransmission (such as the embodiment in FIG. 4) or stopping the transmission of the current target signal, the transmitting circuit TX can transmit the next target signal (such as frame 2). The rules for transmitting, retransmitting or stopping frame 2 are the same as frame 1, thus are omitted for brevity here.

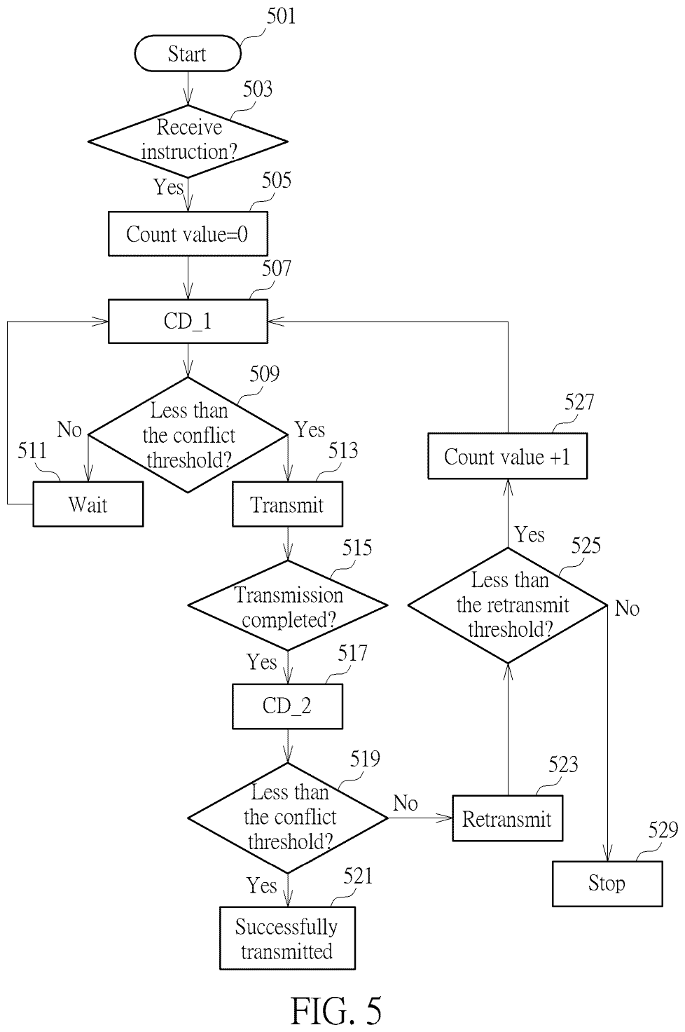

FIG. 5 is a flow chart illustrating operations of the signal transceiving device according to one embodiment of the present invention, which comprises following steps

### Step 501

Start.

### Step 503

The transmitting circuit TX receives the instruction of the transmission target signal. For example, in the embodiments of FIGS. 3 and 4, the instruction of transmitting frame 1 is received.

### Step 505

Set the TX retransmitting count value to 0.

### Step 507

Perform signal energy detection, that is, perform the aforementioned first detecting operation CD_1.

### Step 509

Confirm whether the signal energy is less than the conflict threshold, that is, confirm whether the channel is idle and no signal conflict will occur. If not, go to step 511; if yes, go to step 513.

### Step 511

Return to step 507 after waiting for a period of time.

### Step 513

The transmitting circuit TX transmits the target signal.

### Step 515

Is the transmission of the target signal completed? If yes, go to step 517. If not, stay in step 515 until the transmission is completed.

### Step 517

Perform the second detecting operation CD_2.

### Step 519

Confirm whether the signal energy is less than the conflict threshold, that is, confirm whether the channel is idle and no signal conflict will occur. If yes, go to step 521, if not, go to step 523.

### Step 521

The target signal is successfully transmitted.

### Step 523

It is determined that a signal conflict occurs and the target signal is retransmitted.

### Step 525

Determine whether the number of retransmitting is less than the resend threshold, if so, go to step 527, if not, go to step 529.

### Step 527

The TX retransmitting count value is +1 and goes to step 507.

### Step 529

Stop transmitting the target signal, that is, transmission of the target signal fails.

In one embodiment, the second detecting operation CD_2 is performed after a predetermined time following a time point when the transmitting circuit TX completes transmitting the target signal after the receiving circuit RX completes the first detecting operation CD_1. In one embodiment, the predetermined time is a time which is before the receiving circuit RX enters a stable state, and after the transmitting circuit TX transmits the target signal and the receiving circuit RX simultaneously performs receiving operations. In such case, the predetermined time is also called an unstable state time. The transmitting circuit TX does not performs transmitting operation but the receiving circuit performs a receiving operation in the stable state.

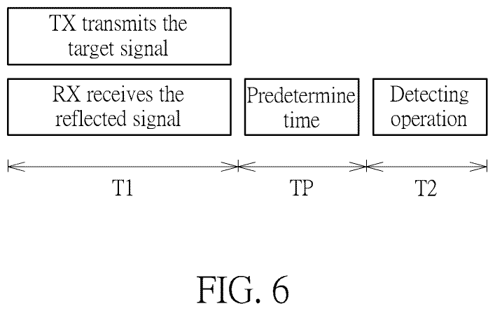

FIG. 6 is a schematic diagram illustrating that the second detecting operation is performed after a predetermined time following a time point when the transmitting circuit transmits the target signal. As shown in FIG. 6, during time T1, the transmitting circuit TX transmits the target signal and the receiving circuit RX performs receiving operations at the same time. After time T1, the transmitting circuit TX and the receiving circuit RX begin to switch and prepare to enter a stable state. Within the predetermined time TP, the receiving circuit RX has not yet entered a stable state. As mentioned before, in the stable state, the transmitting circuit TX does not perform a transmitting operation but the receiving circuit RX performs a receiving operation. During time T2, the receiving circuit RX enters a stable state and can therefore perform the aforementioned detecting operation.

As mentioned above, the signal conflict can be determined based on whether the signal energy in the predetermined frequency band is greater than the conflict threshold. The conflict threshold can be set in a variety of ways. In one embodiment, it is determined according to the following equation:

$$SNR = \frac{P min}{P n o i s e}$$

SNR is the minimum signal-to-noise ratio of the receiving circuit RX, and Pmin is the minimum signal energy that the energy detecting circuit 211 can detect. Therefore, Pnoise is the maximum noise value that the receiving circuit RX can accept. Accordingly, in one embodiment, the conflict threshold is a noise threshold. When it is greater than Pnoise, it is determined that signal conflict may occur.

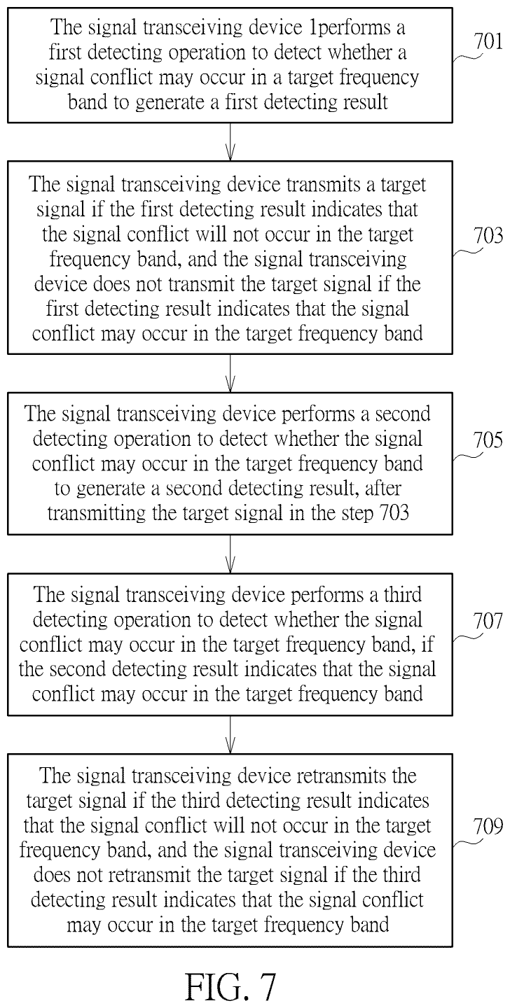

In view of above-mentioned embodiments, a signal conflict detecting method can be obtained, which can be used in the signal transceiving device in FIG. 1. FIG. 7 is a flow chart illustrating a signal conflict detecting method according to one embodiment of the present invention, which comprises the following steps:

### Step 701

The signal transceiving device 100 performs a first detecting operation CD_1 to detect whether a signal conflict may occur in a target frequency band to generate a first detecting result

### Step 703

The signal transceiving device transmits a target signal if the first detecting result indicates that the signal conflict will not occur in the target frequency band, and the signal transceiving device does not transmit the target signal if the first detecting result indicates that the signal conflict may occur in the target frequency band

### Step 705

The signal transceiving device performs a second detecting operation CD_2 to detect whether the signal conflict may occur in the target frequency band to generate a second detecting result, after transmitting the target signal in the step 703.

### Step 707

The signal transceiving device performs a third detecting operation CD_3 to detect whether the signal conflict may occur in the target frequency band, if the second detecting result indicates that the signal conflict may occur in the target frequency band

### Step 709

The signal transceiving device retransmits the target signal if the third detecting result indicates that the signal conflict will not occur in the target frequency band, and the signal transceiving device does not retransmit the target signal if the third detecting result indicates that the signal conflict may occur in the target frequency band.

The present invention has multiple advantages by performing detecting operations before and after transmitting the target signal. For example, when the transmitting circuit TX transmits the target signal, it may cause noise in the receiving circuit RX, which will affect the accuracy of the receiving circuit RX when performing detecting operations. Thus, perform detecting operations before and after transmitting the target signal may increase the accuracy of detecting operations.

For another example, the LNA 203 in the receiving circuit RX will also amplify the noise, thus performs the detecting operation after transmitting the target signal may avoid the noise caused by the transmitting circuit TX to the receiving circuit RX when transmitting the target signal. By this way, the LNA 203 can have a larger amplifying factor and improves the efficiency of the energy detecting circuit 211 in detecting signal energy.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A signal conflict detecting method, applied to a signal transceiving device, comprising:
(a) the signal transceiving device performing a first detecting operation to detect whether a signal conflict may occur in a target frequency band to generate a first detecting result;
(b) the signal transceiving device transmitting a target signal if the first detecting result indicates that the signal conflict will not occur in the target frequency band, and the signal transceiving device not transmitting the target signal if the first detecting result indicates that the signal conflict may occur in the target frequency band;
(c) the signal transceiving device performing a second detecting operation to detect whether the signal conflict may occur in the target frequency band to generate a second detecting result, after transmitting the target signal in the step (b);
(d) the signal transceiving device performing a third detecting operation to detect whether the signal conflict may occur in the target frequency band, if the second detecting result indicates that the signal conflict may occur in the target frequency band; and
(e) the signal transceiving device retransmitting the target signal if the third detecting result indicates that the signal conflict will not occur in the target frequency band, and the signal transceiving device not retransmitting the target signal if the third detecting result indicates that the signal conflict may occur in the target frequency band.

2. The signal conflict detecting method of claim 1, further comprising:
the signal transceiving device performing a fourth detecting operation to detect whether the signal conflict may occur in the target frequency band, after a predetermined time following a time point when the step (e) retransmits the target signal.

3. The signal conflict detecting method of claim 1, wherein the signal transceiving device is a microwave sensor.

4. The signal conflict detecting method of claim 3, the signal transceiving device is a monostatic radar.

5. The signal conflict detecting method of claim 1, wherein the first detecting operation, the second detecting operation and the third detecting operation are operations of detecting a signal energy on the specific frequency band.

6. The signal conflict detecting method of claim 1, wherein the step (c) performs the second detecting operation after a predetermined time following a time point when the transmitting circuit transmits the target signal.

7. The signal conflict detecting method of claim 6,
wherein the signal transceiving device comprises a receiving circuit and a transmitting circuit, and the predetermined time is a time which is before the receiving circuit enters a stable state and after the transmitting circuit transmitting the target signal and the receiving circuit simultaneously performs receiving operations;
wherein the transmitting circuit does not performs transmitting operation but the receiving circuit performs a receiving operation in the stable state.

8. The signal conflict detecting method of claim 1, wherein the target signal is a frame.

9. A signal transceiving device, comprising:
a transmitting circuit;
a receiving circuit; and
a processing circuit, configured to control the transmitting circuit and the receiving circuit to perform following steps:
(a) the receiving circuit performing a first detecting operation to detect whether a signal conflict may occur in a target frequency band to generate a first detecting result;
(b) the transmitting circuit transmitting a target signal if the first detecting result indicates that the signal conflict will not occur in the target frequency band, and the transmitting circuit not transmitting the target signal if the first detecting result indicates that the signal conflict may occur in the target frequency band;
(c) the receiving circuit performing a second detecting operation to detect whether the signal conflict may occur in the target frequency band to generate a second detecting result, after transmitting the target signal in the step (b);
(d) the receiving circuit performing a third detecting operation to detect whether the signal conflict may occur in the target frequency band, if the second detecting result indicates that the signal conflict may occur in the target frequency band; and
(e) the transmitting circuit retransmitting the target signal if the third detecting result indicates that the signal conflict will not occur in the target frequency band, and the transmitting circuit not retransmitting the target signal if the third detecting result indicates that the signal conflict may occur in the target frequency band.

10. The signal transceiving device of claim 9, further comprising:
the receiving circuit performing a fourth detecting operation to detect whether the signal conflict may occur in the target frequency band, after a predetermined time following a time point when the step (e) retransmits the target signal.

11. The signal transceiving device of claim 9, wherein the signal transceiving device is a microwave sensor.

12. The signal transceiving device of claim 11, the signal transceiving device is a monostatic radar.

13. The signal transceiving device of claim 9, wherein the first detecting operation, the second detecting operation and the third detecting operation are operations of detecting a signal energy on the specific frequency band.

14. The signal transceiving device of claim 9, wherein the step (c) performs the second detecting operation after a predetermined time following a time point when the transmitting circuit transmits the target signal.

15. The signal conflict detecting method of claim 14,
wherein the predetermined time is a time which is before the receiving circuit enters a stable state and after the transmitting circuit transmitting the target signal and the receiving circuit simultaneously performs receiving operations;
wherein the transmitting circuit does not performs transmitting operation but the receiving circuit performs a receiving operation in the stable state.

16. The signal transceiving device of claim 9, wherein the target signal is a frame.
